(19) United States
(12) Patent Application Publication
(10) Pub. No.: US 2018/0192088 A1
(43) Pub. Date: Jul. 5, 2018

(54) TRANSMITTING/RECEIVING AUDIO AND/OR VIDEO DATA OVER A WIRELESS NETWORK

(71) Applicant: TRIPLEPLAY SERVICES HOLDINGS LIMITED, London (GB)

(72) Inventors: Peter Martin, Wareham Dorset (GB); Marek Przedwojski, Southampton Hampshire (GB)

(21) Appl. No.: 15/736,538

(22) PCT Filed: Jun. 19, 2015
(86) PCT No.: PCT/GB2015/051802

§ 371 Date: Dec. 14, 2017

(51) Int. Cl. H04N 21/2383; H04N 21/24; H04N 21/2662; H04N 21/414; H04N 21/6377; H04L 29/06

(52) U.S. Cl. CPC H04N 21/2383; H04N 21/2402; H04L 65/607; H04N 21/41407; H04N 21/6377; H04N 21/2662

(57) ABSTRACT

A method of transmitting audio and/or video data to a plurality of client devices over a wireless network. The method includes, at a server: encoding a stream of audio and/or video data to provide an encoded stream of audio and/or video data for transmission over the wireless network; transmitting the encoded stream of audio and/or video data to the plurality of client devices over the wireless network; receiving, from one or more of the client devices, statistics derived from the encoded stream of audio and/or video data as received by the one or more client devices; and modifying the encoding of the stream of audio and/or video data based on the received statistics. The method may be particularly suitable for transmission of audio and/or video data to a large number of client devices in a densely packed environment.

### FIELD OF THE INVENTION

The present invention relates to transmitting/receiving audio and/or video data over a wireless network, e.g. where the audio and/or video data is to be transmitted to a large number of client devices in a densely packed environment.

### BACKGROUND

Delivering live video on multiple mobile devices over a Wi-Fi network in a densely packed environment is a technical challenge due to noise and packet losses when using a wireless delivery medium. Existing solutions use the Hypertext Live Streaming (HLS) protocol as the delivery mechanism.

Technical challenges of streaming Hypertext Live Streaming (HLS) to many client devices can include the need to provide a substantial amount of bandwidth at the network core, server streaming dimensioning and Wi-Fi scaling. To understand these challenges, a traditional approach of streaming HLS to mobile devices over Wi-Fi is described with reference to a portion of a network having a traditional Wi-Fi architecture shown in FIG. 1.

In the network shown in FIG. 1, there are multiple HLS streamer servers 100, which are in essence HTTP servers, a distribution network and a mesh of Wi-Fi access points (“APs”) 106. In practice each AP 106 will have many client devices 108 connected to it at any one time; and the client devices 108 may move between APs 106. To carry a stream of audio and/or video data from the streamers 100 to the Wi-Fi access points 106, the network is provided with a number of core switches 102, connected to the streamers 100 via a first connection 110. Edge switches 104, which are connected to core switches 102 by second connections 112, carry the stream to the APs 106 through third connections 114, 116, 118, 120.

When each client device 108 is viewing the stream of audio and/or video data from the HLS servers 100, there are several data flows involved.

First, an HTTP request from the client device 108 to the server 100 typically involves a wireless automatic repeat request (“ARQ”) sequence between the client device 108 and an AP 106. ARQ is a method of ensuring that packets from a RF (radio frequency) emitter are received intact at a receiver. When using ARQs, each client device has to acknowledge that it has received each packet of data, and any lost packets are then retransmitted to the client device 108. The ARQ thus introduces a positive handshake between a transmitter and a receiver for every packet sent, which can significantly slow down all communications in a busy and/or noisy environment.

A TCP session is typically established from the client device 108 to the HLS servers 100 for each HTTP request. The response from the HLS servers 100 to the client devices 108, as well as the completion and tear-down of the HTTP TCP session, for example when the stream has finished or the user stops viewing the stream, also involves a wireless ARQ. For small numbers of client devices 108 this scales well and is the model used in standard Internet content distribution of live TV to mobile devices. However for large numbers of client devices 108 this model can be inefficient.

For example, if a live video stream is 2 Mbps and there are 50,000 client devices 108 then the HLS streamers 100 would need to provide 100 Gbps of TCP data to the client devices across link 110—clearly a major network to design and manage—and an array of HLS streamers 100 (e.g. 100 such servers) is needed to cope with this demand. In addition, a single AP 106 can typically provide a throughput of 100 Mbps servicing 50 client devices 108, and so in this example a mesh of at least 1000 APs 106 would be required to provide the data to the client devices. This does not take into account the physical locality of many client devices which would require more Aps 106 to provide a good level of service. The end result is a lot of IP traffic on the wired network and a lot of RF traffic.

Examples of other challenges include how to provide an adequate level of service to as many client devices 108 as possible, and how to measure and report the end-to-end system behaviour. Finally, the range of possible client device types, client device behaviours and other factors introduce further challenges.

These challenges are known and work has been done by a number of research groups and commercial entities to try and address them.

One popular approach is to use multicast, as used in a wired LAN environment. This approach introduces new challenges with the RF links because of their inherent lossy behaviour. This lossy behaviour is mitigated when unicast traffic is carried over a Wi-Fi network by a MAC level ARQ protocol which attempts the re-transmission of lost packets. However, as discussed above, this MAC level ARQ is not efficient when using multicast due to the large number of potential clients that may be attempting to join a multicast group address.

Furthermore, multicast does not support HLS, and popular mobile streaming protocols (of which HLS is one) are not designed to be multicast.

Some existing solutions use quasi-multicast by converting multicast packets to unicast, e.g. by sending multicast packets to all of the Wi-Fi access points where they are converted to unicast packets. The unicast packets are then sent to the client devices from the APs. This avoids the core network traffic problem by making use of the standard network multicast efficiencies within the wired network (for example, the use of a smaller number of servers), but still suffers from the ARQ overhead between the APs and client devices, meaning that a large array of APs is still needed.

Another approach that has been investigated is a meshed peer-peer technique to move some of the wireless communications from the AP-client space to the client-client space. This needs the agreement of the clients to do this and specialised algorithms to cope with moving users.

The present invention has been devised in light of the above considerations.

### SUMMARY OF THE INVENTION

A first aspect of the invention may provide a method of transmitting audio and/or video data to a plurality of client devices over a wireless network, the method including, at a server:
encoding a stream of audio and/or video data to provide an encoded stream of audio and/or video data for transmission over the wireless network;
transmitting the encoded stream of audio and/or video data to the plurality of client devices over the wireless network;
receiving, from one or more of the client devices, statistics derived from the encoded stream of audio and/or video data as received by the one or more client devices; and
modifying the encoding of the stream of audio and/or video data based on the received statistics preferably so as to improve the reliability and/or quality of audio and/or video data obtained at the client devices.

By using statistics received from one or more client devices in this way, the server is able to modify its encoding of the stream of audio and/or video data to improve the reliability and/or quality of audio and/or video data obtained at the client devices in a scalable and hardware efficient manner, e.g. without the need for automatic repeat requests (“ARQs”) being sent from the client devices to the server.

As can be seen from the discussion below, the method may be particularly suitable for transmission of audio and/or video data to a large number of client devices in a densely packed environment.

For avoidance of any doubt, the statistics derived from the encoded stream of audio and/or video data as received by the one or more client devices could include statistics derived from the encoded stream of audio and/or video data as received by the one or more client devices in its encoded, decoded and/or partially decoded forms.

For the purposes of this disclosure, encoding a stream of audio and/or video data may be understood as converting the stream of audio and/or video data into a different form.

By way of example, encoding the stream of audio and/or video data may include converting the stream of audio and/or video data from a first format into a second format. Thus, modifying the encoding of the stream of audio and/or video data may include modifying the second file format to which the audio and/or video data is converted.

By way of example, encoding the stream of audio and/or video data may include converting the bitrate of the audio and/or video data to a different value (or different values). Thus, modifying the encoding of the stream of audio and/or video data may include modifying the value(s) of the bitrate(s) to which the audio and/or video data is converted. The value(s) of the bitrate to which the audio and/or video data is converted may be chosen from a group of predetermined values.

By way of another example, if the stream of audio and/or video data includes video data, encoding the stream of audio and/or video data may include converting the resolution of the video data to a different value. Thus, modifying the encoding of the stream of audio and/or video data may include modifying the value of the resolution to which the video data is converted. The new value may be chosen from a group of predetermined values.

By way of another example, encoding the stream of audio and/or video data may include including forward error correcting (“FEC”) codes in the encoded stream of audio and/or video data. Including FEC codes in an encoded stream of audio and/or video data is a known technique for providing redundancy when transmitting data over a noisy communication channel, such as a wireless network. Thus, modifying the encoding of the stream of audio and/or video data may include modifying a parameter (e.g. buffer period), scheme (e.g. interleaving scheme) and/or algorithm used in producing the FEC codes that are included in the encoded stream of audio and/or video data.

By way of another example, encoding the stream of audio and/or video data may include converting of the stream of audio and/or video data into packets. Thus, modifying the encoding of the stream of audio and/or video data may include modifying the formatting (e.g. size) of the packets to which the stream of audio and/or video data is converted.

Modifying the encoding of the stream of audio and/or video data preferably occurs dynamically, i.e. whilst other parts of the encoded stream of audio and/or video data are being transmitted to the client devices.

Modifying the encoding of the stream of audio and/or video data so as to improve the reliability of audio and/or video data obtained at the client devices could include any modification of the encoding suitable for obtaining an improvement in the reliability of audio and/or video data obtained at the client devices. This might include, for example, reducing the value(s) of the bitrate(s) to which the audio and/or video data is converted, reducing the value of the resolution to which the video data is converted, modifying a parameter (e.g. buffer period), scheme (e.g. interleaving) and/or algorithm used in producing the FEC codes that are included in the encoded stream of audio and/or video data to increase redundancy, and/or reducing the size of the packets to which the stream of audio and/or video data is converted. A skilled person will appreciate that these are just examples of how the encoding of the stream of audio and/or video data could be modified so as to improve the reliability of audio and/or video data obtained at the client devices. Reliability of audio and/or video obtained at the client devices may be understood as the reliability with which the audio and/or video data in the encoded stream of audio and/or video data reaches the client devices. Usually, decreasing the quality of the audio and/or video data in the encoded stream of audio and/or video data will result in an improvement in the reliability of audio and/or video data obtained at the client devices, e.g. due to a reduced bitrate in the encoded stream of audio and/or video data.

Preferably, the method includes, at the server, modifying the encoding of the stream of audio and/or video data based on the received statistics so as to improve the reliability of audio and/or video data obtained at the client devices, if the statistics indicate that the reliability of audio and/or video data obtained at the one or more client devices is inadequate, e.g. because a predetermined criterion indicating that the reliability of audio and/or video data obtained at the one or more client devices is inadequate has been met.

A predetermined criterion indicating that the reliability of audio and/or video data obtained at the one or more client devices is inadequate may be based, for example, on an average value calculated from the number of packets of the encoded stream of audio and/or video data received with errors which could not be corrected using the FEC codes received from each of the one or more client devices. For example, the predetermined criterion could be met if this average value exceeds a predetermined threshold. A skilled person will appreciate this is just one way in which the statistics could indicate that the reliability of audio and/or video data obtained at the one or more client devices is inadequate.

Modifying the encoding of the stream of audio and/or video data so as to improve the quality of audio and/or video data obtained at the client devices could include any modification of the encoding suitable for obtaining an improvement in the quality of audio and/or video data obtained at the client devices. This might include, for example, raising the value(s) of the bitrate(s) to which the audio and/or video data is converted, raising the value of the resolution to which the video data is converted, and/or increasing the size of the packets to which the stream of audio and/or video data is converted. A skilled person will appreciate that these are just examples of how the encoding of the stream of audio and/or video data could be modified so as to improve the quality of audio and/or video data obtained at the client devices. Usually, increasing the quality of the audio and/or video data in the encoded stream of audio and/or video data will result in a reduction in the reliability of audio and/or video data obtained at the client devices, e.g. due to an increased bitrate in the encoded stream of audio and/or video data.

Preferably, the method includes, at the server, modifying the encoding of the stream of audio and/or video data based on the received statistics so as to improve the quality of audio and/or video data obtained at the client devices, if the statistics indicate that the reliability of audio and/or video data obtained at the one or more client devices is adequately high to permit an increase in quality, e.g. because a predetermined criterion indicating that the reliability of audio and/or video data obtained at the one or more client devices is adequately high to permit an increase in quality has been met.

A predetermined criterion indicating that the reliability of audio and/or video data obtained at the one or more client devices is adequately high to permit an increase in quality may be based, for example, on an average value calculated from the number of packets of the encoded stream of audio and/or video data received with errors which could not be corrected using the FEC codes received from each of the one or more client devices. For example, the predetermined criterion could be met if this average is below a predetermined threshold. A skilled person will appreciate this is just one way in which the statistics could indicate that the reliability of audio and/or video data obtained at the one or more client devices is adequately high to permit an increase in quality.

Preferably, the method includes, at the server, selecting a subset of client devices from which statistics are to be requested and polling the selected subset of client devices to request statistics. The subset of client devices may be selected at random, quasi-randomly, or systematically, for example. The subset of client devices may be selected from a list of registered client devices (see below).

Selecting a subset of the client devices is advantageous because it reduces wireless network traffic.

For the avoidance of any doubt, the subset of client devices may include one or more of the client devices, though it is preferred for the subset of client devices to include a plurality of the client devices.

Also for the avoidance of any doubt, the one or more client devices (from which statistics are received) might not include all of client devices from which statistics are requested, e.g. since some client devices might not respond.

Preferably, the method includes repeatedly selecting and polling a new subset of client devices, e.g. at predetermined time intervals and/or if a predetermined criterion (e.g. a measure of traffic in the wireless network reaching a predetermined value) is met. Each new subset of client devices may be selected at random, quasi-randomly, or systematically, for example. Each new subset of client devices may be selected from a list of registered client devices (see below). Preferably, each new subset of client devices is selected quasi-randomly or systematically so that at least a predetermined proportion or all of the registered client devices are selected over a given time period.

Preferably, the rate at which client devices are polled to request statistics (e.g. the number of client devices polled per unit time) is modified based on a measure of traffic in the wireless network (which may be calculated as described above). For example, the rate at which client devices are polled to request statistics could be decreased if a measure of traffic in the wireless network meets a criterion indicating heavy traffic. For example, the rate at which client devices are polled to request statistics could be increased if a measure of traffic in the wireless network meets a criterion indicating light traffic.

Note that the rate at which client devices are polled to request statistics could be changed indirectly, e.g. by reducing the size of each new subset of client devices selected, or by changing the frequency with which client devices are polled to request statistics.

The method may include, at the server, recording the times taken for statistics to be received from the subset of client devices. The recorded times may be used to calculate or otherwise provide a measure of traffic in the network (which may for example be used to modify the rate at which client devices are polled to request statistics). The times taken for statistics to be received from the subset of client devices may be used to remove (e.g. unresponsive) client devices from a list of registered client devices maintained at the server.

The method may include, at the server, maintaining a list of registered client devices.

The method may include, at the server, adding a client device to the list of registered client devices if a request is received from the client device.

The method may include removing a client device from the list of registered client devices if the server does not receive statistics from the client device after the client device has been polled by the server a predetermined number of times. For the avoidance of any doubt, the predetermined number may be one.

By way of example, the statistics received from the one or more client devices may include a number of packets of the encoded stream of audio and/or video data as received by each client device (in the one or more client devices).

By way of example, the statistics received from the one or more client devices may include, for each client device in the one or more client devices, a number of packets of the encoded stream of audio and/or video data received with errors by each client device (in the one or more client devices).

By way of example, if encoding the stream of audio and/or video data includes including FEC codes in the encoded stream of audio and/or video data, then the statistics received from the one or more client devices may include: a number of packets of the encoded stream of audio and/or video data received with errors which could be corrected using the FEC codes by each client device (in the one or more client devices) and/or a number of packets of the encoded stream of audio and/or video data received with errors which could not be corrected using the FEC codes by each client device (in the one or more client devices).

As discussed in more detail below (in relation to the third aspect of the invention), each client device preferably collects its own statistics derived from the encoded stream of audio and/or video data it receives, with these statistics being sent to the server if the client device is polled by the server.

So, for the avoidance of any doubt, the statistics derived from the encoded stream of audio and/or video data as received by the one or more client devices may be made up of statistics separately collected and sent to the server from individual client devices.

However, in other embodiments, one or more client devices could collect and send statistics to the server on behalf of other client devices.

The stream of audio and/or video data may be a live stream of audio and/or video data, i.e. audio and/or video captured at the same time as other parts of the encoded stream of audio and/or video data are being transmitted to the client devices.

The stream of audio and/or video data may have a first format. For example, the first file format may be H.264 video with AAC audio.

The encoded stream of audio and/or video data may have a second format. For example, the second file format may be an MPEG-2 transport stream carrying H.264 video with AAC audio.

Preferably, transmitting the encoded stream of audio and/or video data to the plurality of client devices over the wireless network includes transmitting the encoded stream of audio and/or video data as a multicast, i.e. such that the same encoded stream of audio and/or video data is transmitted to each of the plurality of client devices.

Preferably, the wireless network may be a wireless local area wireless network. Such a network is typically referred to as a “Wi-Fi” network. However, in other embodiments, the wireless network could be a cellular wireless network.

The wireless network may include a plurality of wireless access points.

The wireless network may include a plurality of edge switches and one or more core switches.

The method may be particularly suitable for transmission of audio and/or video data to a large number of client devices in a densely packed environment.

For example, in some embodiments, the plurality of client devices may include 100 or more client devices, may include 1000 or more client devices, or may include 10,000 or more client devices. A typical deployment for this method may be anywhere between 100 and 50,000 client devices.

For example, in some embodiments, the wireless network may include 10 or more wireless access points, may include 100 or more wireless access points, or may include 1000 or more wireless access points.

For example, in some embodiments, the wireless access points may be located within 3 km of each other, or may be located within 1 km of each other, or may be located within 100 m of each other, or may be located within 10 m of each other.

The client devices preferably include mobile devices, e.g. mobile phones or tablet computers.

The method may avoid the use of ARQs.

The method may avoid the use of HLS.

A second aspect of the invention may provide a server for performing a method according to the first aspect of the invention.

Thus, the second aspect of the invention may provide a server for transmitting audio and/or video data to a plurality of client devices over a wireless network, the server being configured to
encode a stream of audio and/or video data to provide an encoded stream of audio and/or video data for transmission over the wireless network;
transmit the encoded stream of audio and/or video data to the plurality of client devices over the wireless network;
receive, from one or more of the client devices, statistics derived from the encoded stream of audio and/or video data as received by the one or more client devices; and
modify the encoding of the stream of audio and/or video data based on the received statistics preferably so as to improve the reliability and/or quality of audio and/or video data obtained at the client devices.

The server may be configured to implement, or have means for implementing, any method step described performed by the server in connection with any above aspect of the invention.

The server may be configured to receive a stream of audio and/or video data from an audio and/or video source.

The server may include a video encoder and a video streamer configured to convert the stream of audio and/or video data from a first format into a second format. The new format may be, for example, a H.264 video stream with AAC audio.

The server may include a transcoder configured to convert the bitrate of the audio and/or video data to a different value (or different values) and convert the resolution of the video data (if included in the stream) to a different value.

The server may include a forward error correction (FEC) encoder configured to include FEC codes in the encoded stream of audio and/or video data.

The server may be configured to convert the stream of audio and/or video data into packets.

The server may include a multicast transmitter configured to transmit the encoded stream of audio and/or video data as a multicast, i.e. such that the same encoded stream of audio and/or video data is transmitted to each of the plurality of client devices.

The server may include a client register configured to maintain a list of registered client devices.

The server may include a performance manager configured to modify the encoding of the stream of audio and/or video data based on the received statistics.

The server may include a stats monitor configured to receive, from one or more of the client devices, statistics derived from the encoded stream of audio and/or video data as received by the group of client devices.

For the avoidance of any doubt, the server may be a distributed server including a plurality of subservers. The server may include a plurality of hardware elements that could each be viewed as a respective server.

A third aspect of the invention may provide a method of receiving audio and/or video data from a server over a wireless network, the method comprising, at a client device:
receiving an encoded stream of audio and/or video data over the wireless network, wherein the encoded stream of audio and/or video data was formed by encoding a stream of audio and/or video data;
decoding the encoded stream of audio and/or video data to obtain a decoded stream of audio and/or video data;
collecting statistics derived from the encoded stream of audio and/or video data; and
if the client device is polled by the server, transmitting the statistics to the server over the wireless network.

For avoidance of any doubt, the statistics derived from the encoded stream of audio and/or video data could include statistics describing the encoded stream of audio and/or video data in its encoded, decoded and/or partially decoded forms.

The client device may be configured to implement, or have means for implementing, any method step performed by the client device as described in connection with any above aspect of the invention.

The method may include, at the client device, sending a request to add the client device to a list of registered client devices maintained at the server. The request may be in the form of an HTTP request, for example. The request may contain information about the client device and/or user.

As described in connection with the first aspect of the invention, the encoded stream of audio and/or video data may be transmitted to the client device as a multicast. The method may include, at the client device, joining a multicast group in order to receive the encoded stream of audio and/or video data transmitted as a multicast, as is typically required for a multicast transmission. Joining the multicast group may be performed separately from sending the request to add the client device to a list of registered client devices.

The method may include, at the client device, playing the decoded stream of audio and/or video data. For example, the client device may play the decoded stream of audio and/or video data if an error rate in the decoded stream (e.g. as indicated by the statistics) is below a predetermined threshold. Additionally of alternatively, the client device may display a notice if an error rate in the decoded stream (e.g. as indicated by the statistics) is above a predetermined threshold.

Preferably, the method includes modifying the decoding of the encoded stream of audio and/or video data if the encoding of the encoded stream of audio and/or video data has been modified.

Modifying the decoding of the encoded stream of audio and/or video data preferably occurs dynamically, i.e. whilst other parts of the encoded stream of audio and/or video data are being received.

Decoding the encoded stream of audio and/or video data may include using FEC codes included in the encoded stream of audio and/or video data.

By way of example, the statistics collected by the client device may include a number of packets of the encoded stream of audio and/or video data as received by the client device.

By way of example, the statistics collected by the client device may include a number of packets of the encoded stream of audio and/or video data received with errors by the client device.

By way of example, if the stream of audio and/or video data includes FEC codes, the statistics collected by the client device may include a number of packets of the encoded stream of audio and/or video data received with errors which could be corrected using the FEC codes by the client device and/or a number of packets of the encoded stream of audio and/or video data received with errors which could not be corrected using the FEC codes by the client device.

A method according to the third aspect of the invention may be performed (respectively) at each of a plurality of client devices.

A method according to the third aspect of the invention may be performed in addition to a method according to the first aspect of the invention.

A fourth aspect of the invention may provide a client device for performing a method according to the third aspect of the invention.

Thus, the fourth aspect of the invention may provide, a client device configured to
receive an encoded stream of audio and/or video data over the wireless network, wherein the encoded stream of audio and/or video data was formed by encoding a stream of audio and/or video data;
decode the encoded stream of audio and/or video data to obtain a decoded stream of audio and/or video data;
collect statistics derived from the encoded stream of audio and/or video data; and
if the client device is polled by the server, transmit the statistics to the server over the wireless network.

The client device may include a Wi-Fi stack configured to receive the encoded stream of audio and/or video data.

The client device may also include a multicast receiver configured to receive the encoded stream of audio and/or video data transmitted as a multicast.

The client device may include a stats responder configured to collect the statistics and (if the client device is polled by the server) transmit the statistics to the server over the wireless network.

The client device may include a decoder configured to decode the encoded stream of audio and/or video data to obtain the decoded stream of audio and/or video data.

The client device may include a video player configured to play the decoded stream of audio and/or video data. The video player may also be configured to display a notice if the statistics indicate that the error rate of the decoded stream of audio and/or video data is above a predetermined threshold.

A fifth aspect of the invention may provide a computer-readable medium having computer-executable instructions configured to cause a server to perform a method according to the first aspect of the invention.

A sixth aspect of the invention may provide a computer-readable medium having computer-executable instructions configured to cause a client device to perform a method according to the third aspect of the invention.

The computer-executable instructions may be provided as an application (“app”) downloadable from an online application store (“app store”). The application may be configured to receive an encoded stream of audio and/or video data from a server as described above.

The invention also includes any combination of the aspects and preferred features described except where such a combination is clearly impermissible or expressly avoided.

### BRIEF DESCRIPTION OF THE DRAWINGS

Examples of these proposals are discussed below, with reference to the accompanying drawings in which:

FIG. 1 shows a portion of a network having a traditional Wi-Fi architecture.

FIG. 2 shows a portion of a network having an architecture capable of implementing the present invention.

FIG. 3 shows the network of FIG. 2 in further detail.

### DETAILED DESCRIPTION

In general, the following discussion describes examples of our proposals that may permit the streaming of live content to a large number of mobile devices connected to a network using Wi-Fi. For example, the present invention may be found in sports arenas where a large number of users are concentrated in a small space.

In some examples, Forward Error Correcting (“FEC”) codes together with an adaptive feedback system are used so that the system overall can dynamically modify the encoding of the stream of audio and/or video data, e.g. by adjusting transmission and/or coding parameters, to maximise the overall user quality of experience, network bandwidth efficiency, and/or respond to changing environments and error patterns. In some examples, to avoid large amounts of additional network traffic for the proposed feedback mechanism, statistical sampling of the connected client devices may be used to build a picture of the overall system behaviour.

In some examples, the use of FEC codes can eliminate the use of ARQs. Encoding the data with FEC codes can also allow the receiver (a client device) to detect and repair a number of errors which occur in the data transmitted over the wireless network. This means that these packets do not need to be retransmitted by the server, reducing traffic over the network. According to some embodiments, there is no need to retransmit any lost packets, further reducing traffic through the network.

The approach proposed herein could be applied to any system where reliable delivery of multicast traffic is required over an unreliable medium such as a Wi-Fi network.

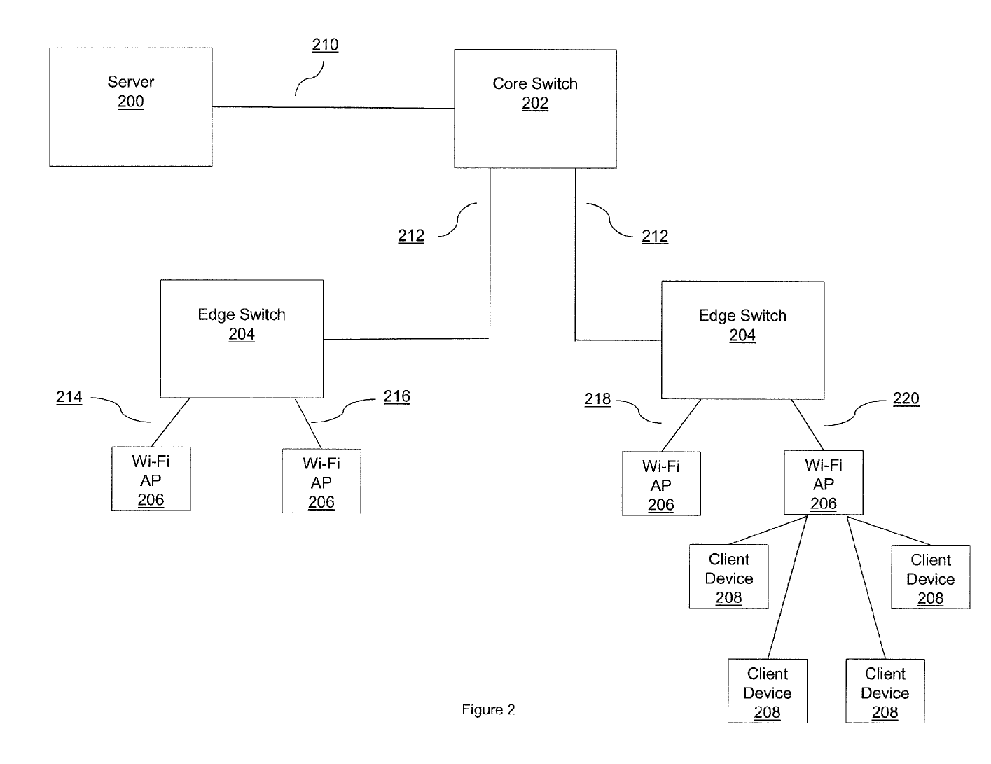

An example network architecture able to implement the present invention is described below with reference to FIG. 2.

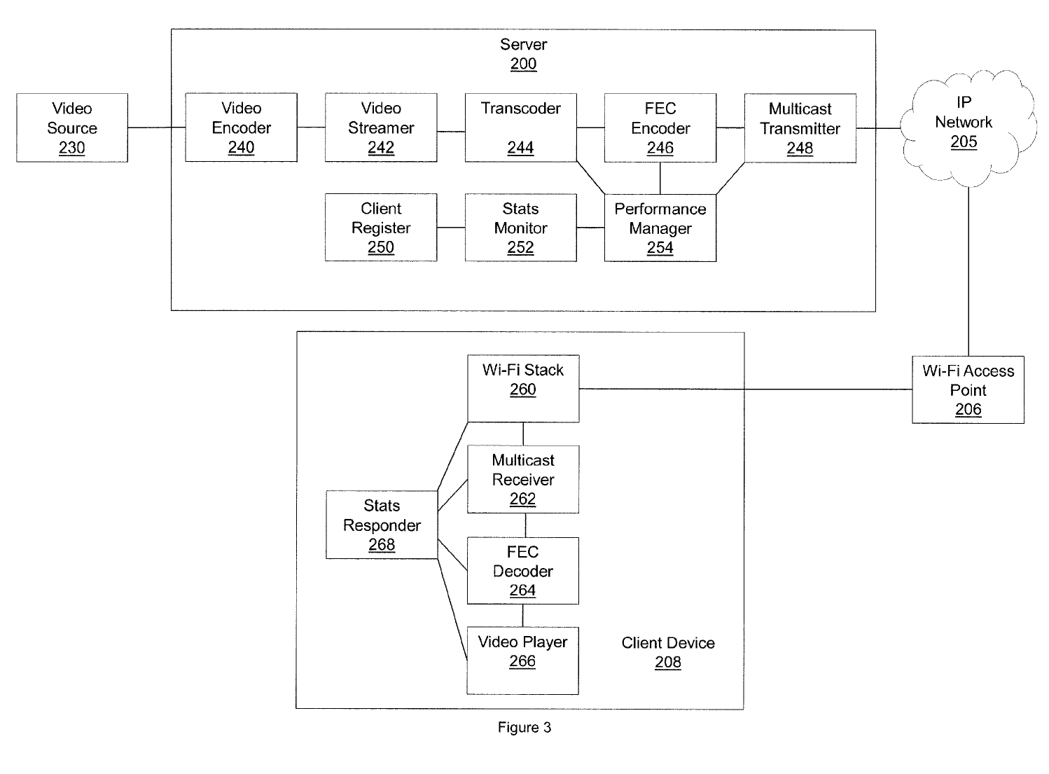

A process for transmitting audio and video data to a plurality of client devices over a network will now be described with reference to the network partially shown in FIG. 2 and FIG. 3.

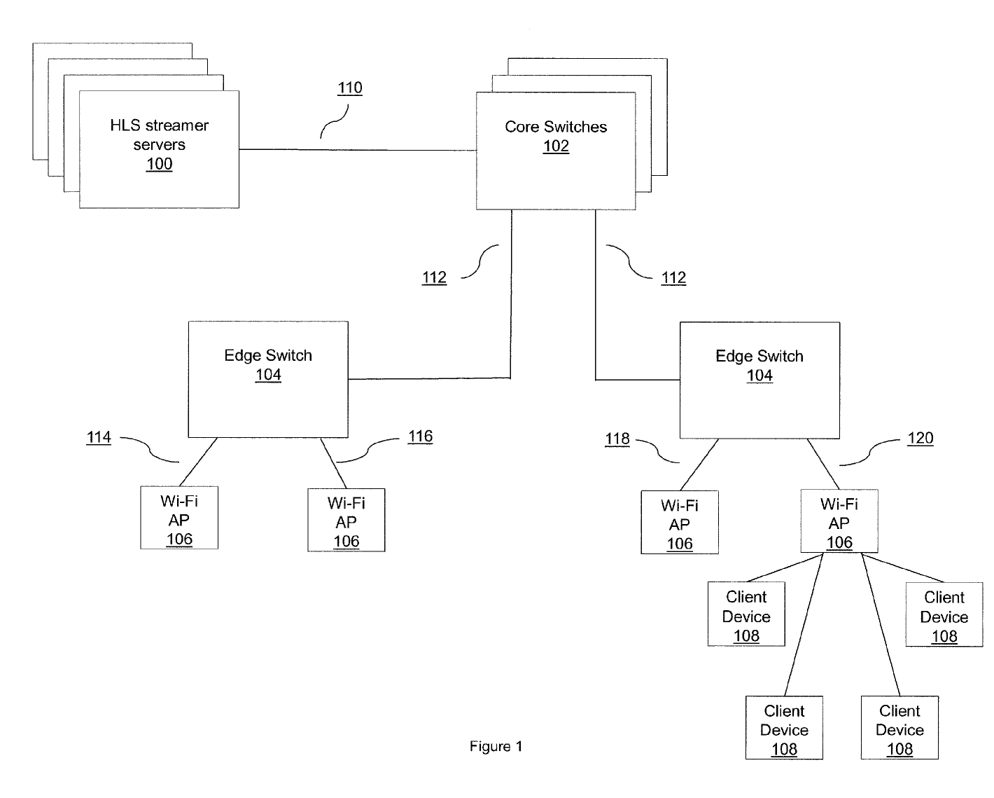

The network of FIG. 2 is a Wi-Fi network similar to that of FIG. 1. Alike features have therefore been given corresponding reference numerals and need not be discussed further herein.

Unlike the network of FIG. 1, the network of FIG. 2 includes a server 200 in place of the HLS streamer servers 100. The server 200 of FIG. 2 may be referred to as a “streamer” or “headend”.

Also unlike the network of FIG. 1, the network of FIG. 2 includes only a single core switch 202 which handles a reduced bandwidth compared to the network of FIG. 1 since, for reasons discussed below, the process implemented on the network of FIG. 2 is able to more efficiently deliver data to a large number of client devices 208 compared with the technique discussed above with reference to FIG. 1.

The network partially shown in FIG. 2 able to provide a live video stream to an application on a client device via a Wi-Fi network.

In a first step of the process, a stream of audio and video data (which may be referred to as a “video signal”) is received from a video source 230 such as a video camera. Preferably, the stream of audio and video data is a live stream of audio and video data captured whilst the process is being performed. In this particular example, if the stream of audio and video data is not already delivered to the server 200 as H.264 video with AAC audio, then it is converted to a full rate H.264 video by a video encoder 240 and a video streamer 242. H.264 video is used in this particular example since a majority of client devices currently available, e.g. mobile phones, smartphones, tablets etc., are configured to be able to use this format. Of course, in alternative examples, alternative audio and/or video formats could be used.

Next, the full rate H.264 video is converted to have a reduced bitrate and reduced resolution, for example by converting the H.264 video an encoded stream of data which in this example is an MPEG-2 transport stream carrying a single H.264 video elementary stream and a single AAC stereo audio elementary stream. The conversion of the stream of audio and video data to the transport stream is carried out by a transcoder 244. In this example, the video bitrate and audio bitrate to which the stream of audio and video data are converted, as well as the video resolution to which the video data is converted, may initially be chosen from a group of predetermined values.

The transport stream is passed through a further encoding stage at a forward error correction (FEC) encoder 246, which transforms the transport stream into Forward Error Correction (FEC) codes designed to carry the original transport stream information and to allow an application on a receiving client device 208 to repair missing packets. The choice of the FEC code, buffering period and the coding parameters may initially be chosen from a group of predetermined values.

Next, the FEC coded packets from the FEC encoder 246 are combined with the transport stream and packetised at the multicast transmitter 248 to form a UDP (User Datagram Protocol) multicast stream of data to be transmitted to the client devices 208 as a multicast stream of data.

The UDP multicast stream of data can be viewed as an encoded stream of audio and video data, and elements 240, 242, 244, 246, 248 described above can all be viewed as encoding the stream of audio and video data received from the video source 230 to provide the encoded stream of audio and video data.

Next, the multicast data stream is transmitted over a (wired) Ethernet IP network 205 and passed to wireless access points 206 where it is transmitted to a multicast group comprising a number of client devices joined to that group. Multicast is well known in the art and need not be discussed further.

By way of example, the server 200 may be a single server configured to transmit a multicast data stream to a number access points designed to handle multicast traffic, such as the Ruckus 7982 AP and the associated Zone Director 1100.

An example client device 208 is shown in FIG. 3. This device is a mobile device which is provisioned with an application to receive the encoded stream of audio and video data from the server 200. The client device is added to a list of registered client devices maintained at the server 200 (i.e. registered with the server 200) using the application, e.g. by the application sending a request to add the client device to the list of registered client devices maintained at the server 200. The request could for example be in the form of a standard HTTP request containing information about the client device 208.

The application may be a dedicated mobile application, e.g. downloaded from an app store onto the client device 208. The application may include a video player. This application may be linked to a particular organisation or location, such as a sporting club (such as a football club), stadium or arena.

The user may register with the server 200 using the application by providing an email address or other information. For example, the user may use the application to register an email address with the server 200 when they arrive at an arena or stadium for an event.

The registration by the user may take place in the streaming environment (e.g. a football stadium or other sporting arena) as information about the client device is received by the server 200. A client register 250 on the server 200 maintains the list of registered client devices.

The client device 208 joins the required multicast group after it has been registered with the server 200 in the manner described above. If there is more than one multicast group available, the desired multicast group can be specified by the user through the application on the client device 208.

Once the application has joined the desired multicast group, the mobile device 208 starts to receive the encoded stream of audio and video data from an access point 206 using a Wi-Fi device and stack 260 on the client device 208.

Note that there may be a number of different multicast groups available in a given streaming environment (e.g. a football stadium), with each multicast group corresponding to a different encoded stream of audio and/or video data.

The application on the mobile device receives the encoded stream of audio and video data at a multicast receiver 262 and decodes, at an FEC decoder 264, the FEC encoded packets to reconstruct the original transport stream, which as discussed above may be an MPEG-2 transport stream carrying a single H.264 video elementary stream and a single AAC stereo audio elementary stream.

The use of FEC codes allows the application to detect errors in packets of the encoded stream of audio and video data. The FEC decoder 264 is then able to correct errors without needing to request retransmission of data, as would be necessary if ARQs were used. The traffic being sent from the client device 208 back to the APs 206 and/or the server 200 is therefore significantly reduced. The FEC decoder 264 may not be able to correct all of the errors in the encoded stream of audio and video data, and any packets containing errors which cannot be corrected are not used to reconstruct the transport stream, but are simply left out of the decoded stream of audio and/or video data obtained at the client device 208.

In this particular example, the FEC decoder 264 collects statistics derived from the encoded stream of audio and video data as received by the client device 208. The collected statistics (which could be referred to as “streaming statistics”) could include how many packets of the encoded stream of audio and video data were received, how many packets were received with errors that could not be corrected, how many packets were received with errors that were correctable and how many packets were received without any errors.

If an error rate seen by the FEC decoder 264 is below a predetermined threshold, then the FEC decoder 264 may send the decoded audio and/or video stream to a video player 266 on the mobile device 208 so that the video player 266 presents the user with the audio and video content. If an error rate seen by the FEC decoder 264 is above a predetermined threshold, the application may presents the user with a notice indicating that the stream is temporarily unavailable.

Periodically, e.g. after a predetermined interval of time has elapsed, the server 200 may select a subset of client devices 208 from the list of registered client devices 208 and poll the selected subset of client devices to request their current streaming statistics. The client devices 208 respond to the request by transmitting their statistics to the server 200, e.g. in the form of an HTTP message, where is the statistics are processed by the stats monitor 252. The number of client devices 208 sampled can be varied in order to keep the overall traffic at a manageable level at the server 200 and/or in the wireless network.

The server 200 may record the successful receipt of statistics from each client device 208 from which the statistics have been collected (since, as noted previously, statistics might not be received from each client device 208 from which statistics have been requested).

The server 200 may record the times taken (“latencies”) for statistics to be received from client devices in response to requests for statistics from the client devices. The recorded times may be used to calculate or otherwise provide a measure of traffic in the network to be calculated by the server. If the measure of traffic meets a criterion indicating heavy traffic, the rate at which statistics are requested may be reduced.

By way of example, a subset of client devices 208 could be selected every few hundred milliseconds, or may be selected every second. The subset of client devices may be randomly selected for each subset or may be systematically or quasi-randomly selected for each subset such that a large a number of the registered clients (for example, all of the registered clients) are selected over a given time period. As an example, the server 200 may select a subset of two-hundred client devices 208 each second, and request their current streaming statistics by polling the subset of client devices 208. If requested, the streaming statistics of the client devices 208 are sent to the server 200 by a stats responder 268, which is configured to collect the statistics and (if the client device is polled by the server) transmit the statistics to the server over the wireless network.

The number of client devices in each subset, the size of the subset, and/or the interval between subsets being selected may be dynamically varied, e.g. based on a measure of traffic in the network, e.g. to maximise the data sent to the server 200 and/or minimise the effect on data flow through the network. The number of client devices in each subset could also be varied depending on the available hardware and available processing power.

Client devices 208 which do not respond are marked in the server 200 as having not responded. This may be recorded in the client register 250.

Next, the stats monitor 252 uses the information collected from the client devices to tell the performance manager 254 to modify the encoding of the stream of audio and/or video data, e.g. using an algorithm designed to improve reliability and/or quality of data obtained by the client devices, e.g. by maximising network throughput and/or minimising the errors experienced by the client devices. An example algorithm is discussed below. The modifications to parameters is preferably done dynamically and in real time, while the encoded stream of audio and video data is being transmitted, allowing rapid adaptation to changing conditions. Parameters in the FEC coding that may be modified can include the FEC scheme and FEC buffering period. Other parameters which can be varied include the bitrate and/or resolution of the audio and/or video data, and packet size. The stats monitor 252 may also provide management information and system alerts to keep the system administration up to date with how the system is performing.

Client devices which are marked as having not responded and/or do not respond to a predetermined number of requests for statistics may be removed from the list of registered client devices by the client register 250, in which case such devices 208 are no longer considered for requests for statistics until the user once again registers the client device 208 with the server 200. Such client devices 208 may be, for example, turned off and so removing them from the list of registered client devices helps to reduce unnecessary traffic transmitted over the wireless network.

The success and response times from the client devices 208 which have sent their statistics may be used by the server 200 to adjust the number of clients in the subset of client devices from which statistics are requested.

The following discussion describes an example algorithm designed to improve reliability and/or quality of data obtained by the client devices by modifying the encoding of a stream of audio and/or video data based on statistics derived from an encoded stream of audio and video data as received by a plurality of client devices. Of course, this algorithm is only an example, and many other possible algorithms for achieving these effects could be devised by a skilled person based on the teaching herein.

Preferably, the performance manager 254 receives statistics (which may be referred to as “stats information”) from a sample of the client devices 208 and uses this to build an internal model of the whole population of all client devices 208. The total size of the population may be initially derived from the client register 250 and may be modified over time as the client register 250 is updated and further concrete statistics are collected from the population. The model may allow further sub-populations to be constructed, e.g. to estimate the numbers of specific device types with known weaknesses.

As is known in the art, a stream of audio and/or video data that includes FEC codes (which may be referred to as an “FEC stream”) may be organized into atomically encoded/decoded subblocks that include packets of the original data (i.e. the original audio and/or video data) and packets of repairing data (i.e. FEC codes). Packets may be stacked in rows with encoding/decoding performed using columns. The size of the subblocks is typically determined based on the codec used and computational time required for decoding. For example, due to performance issues, the Reed-Solomon codec typically operates on relatively small size subblocks, but guarantees recovery given an adequate number of repairing packets. In comparison the LDPC-staircase codec can use relatively large size subblocks but is probabilistic in nature and recovery is not guaranteed and consequently it is normally desirable for the FEC stream to include additional packets of repairing data to minimize the probability of a decode failure, resulting in a greater transmission overhead (i.e. more data being transmitted). The loss of a packet by the network turns into the loss of a single symbol (piece of information) in each column, and recovering from that situation is possible provided the packet loss rate in a single subblock does not exceed a specified threshold. Also, to avoid the concentration of error bursts in a subblock, which may result in an inability to decode, the subblocks may be scrambled into larger interleaving buffers and packets may be sent in a random order, which allows the system to disperse the burst loss among different subblocks.

The example algorithm, which may be implemented by the performance manager 254, preferably performs an analysis of the collected data.

Using the algorithm, decisions may be made based on the collected data to minimize, in order of importance:
FPLR: Packet loss rate in the final stream delivered to the client devices 208
D: Stream delay introduced by buffering
B: Bandwidth usage experienced by the access points 206

Using the algorithm, further decisions may aim to maximise the user experience on the client devices 208 in terms of picture quality and the absence of visible artefacts. Decision variables may include:
vbr: Encoding bitrate of the transcoder 244.
bs: Size of the buffer for interleaving in the FEC encoder 246 which allows the system to disperse the burst packet loss over a period of time.
r: Number of repairing packets introduced by the FEC encoder 246.
c: FEC codec used in the FEC encoder 246

Due to the complexity of the original problem (i.e. the problem of minimizing the three variables noted above) and the possible inability of the client devices 208 to access data, the algorithm may use heuristic rules based on previous experience. The algorithm may solves the original problem by introducing different periods, e.g. T1 and T2, over which the decision variables may change, thus reducing the complexity of the original problem.

Particular rules/considerations may apply to the decision variables, for example:
vbr: The video codec data rate may be fixed before the algorithm is run, and may only be changable between runs of the algorithm. This may be useful e.g. since dynamic video bit rate changing in the case of h.264 is not well supported.
bs: The increase of size of the interleaving buffer is an operation that introduces additional delay that may result in a visible freeze at client devices. The update interval may therefore be set to T2.
r, c: The number of repairing packets and FEC codec used may be changeable dynamically, smoothly adapting to the situation. The update interval may be set to T1.

Because the cost of changing bs is high, T2 is preferably significantly greater than T1. T1 may depend on the size of the population.

The algorithm may start with initial settings including thresholds, decision variables, number of repairing packets, interleaving buffer lengths and the h.264 video codec bitrate and resolution. The values of these settings are preferably pre-set and may be determined based on previous runs of the algorithm. During operation the algorithm preferably collects information about the packet loss rate in stack buffers from client devices 208 and the success/failure history of packet delivery. The algorithm preferably computes the number of repairing packets needed for improved error recovery, e.g. by predicting the future situation taking into account the bandwidth required and the computational complexity of decoding on the client devices 208. The algorithm may also change the FEC codec used, choosing the one with the best characteristics. Particular decisions (e.g. selecting an FEC codec) may be adjustable based on previous experience. For example, if successful recovery of data cannot be guaranteed in all, most or a predetermined proportion of cases, the algorithm may consider whether the length of the interleaving buffer should be increased, albeit at the cost of a possible visible freeze in the delivered stream. The particular conditions leading to a change decision may be subject to adjustment. The algorithm preferably analyses success/failure history of packet delivery and computes a new interleaving buffer length, albeit at the expense of an introduced delay. If the new interleaving buffer length value reduces the loss rate significantly, the new buffer length value may introduced to the transmitted stream.

The algorithm may include the following steps:
1. Set the initial values of vbr, bs, r, c
2. Collect anonymous statistics over a period of T1.
3. Analyse packet loss rate (IPLR) in the intermediate FEC stream reported in the last period.

New values of r and c may be calculated if necessary.

An optimal value of r that may guarantee recovery could be set as max(IPLR)+overhead(c), where max(IPLR) is the maximum packet loss rate across the population.

The number of repairing packets (r) may be taken as being directly correlated with bandwidth usage (B). Increased bandwidth usage may decrease clients experience using other services and also may increase the risk of collisions in transmissions, thus increasing IPLR. The resulting choice may therefore be seen as a balance between optimal value of r and B, which are subject to adjustment.

The codec used (c) may be chosen based on the value of (r) and codec profile.
4. If a period T2 has passed since a last change of bs, analyse past statistics and calculate an optimal value of bs for which the difference between benefits of having this value and the cost of introduced delay is the greatest. Decrease calculated optimal difference by the cost of introducing the change to the stream and compare with the difference calculated for the current bs value. If it is greater, introduce the change to the stream.

Particular forms of the benefit function and the cost functions may be adjusted based on the previous experience.
5. Go to step 2.

When used in this specification and claims, the terms “comprises” and “comprising”, “including” and variations thereof mean that the specified features, steps or integers are included. The terms are not to be interpreted to exclude the possibility of other features, steps or integers being present.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For example, alternative access points can be substituted, though preferably the access points allow multicast traffic to be transmitted and can operate in the physical environment as required.

As another example, although the example process described above uses FEC codes, such codes may be omitted, since the modification of the encoding based on the statistics could be done so as to reduce errors at the client devices 208, e.g. such that FEC codes are not required. In these arrangements, the FEC encoder 246 in the server 200 and the FEC decoder 264 in the client device 208 may be omitted.

For the avoidance of any doubt, any theoretical explanations provided herein are provided for the purposes of improving the understanding of a reader. The inventors do not wish to be bound by any of these theoretical explanations.

All references referred to above are hereby incorporated by reference.

1.-22. (canceled)

23. A method of transmitting audio and/or video data to a plurality of client devices over a wireless network, the method including, at a server:
encoding a stream of audio and/or video data to provide an encoded stream of audio and/or video data for transmission over the wireless network;
transmitting the encoded stream of audio and/or video data to the plurality of client devices over the wireless network;
receiving, from one or more of the client devices, statistics derived from the encoded stream of audio and/or video data as received by the one or more client devices; and
modifying the encoding of the stream of audio and/or video data based on the received statistics.

24. A method according to claim 23, wherein modifying the encoding includes modifying the encoding of the stream of audio and/or video data based on the received statistics so as to improve the reliability and/or quality of audio and/or video data obtained at the client devices.

25. A method according to claim 23, wherein encoding the stream of audio and/or video data includes converting the bitrate of the audio and/or video data to a different value or different values, wherein modifying the encoding of the stream of audio and/or video data includes modifying the value(s) of the bitrate(s) to which the audio and/or video data is converted.

26. A method according to claim 23, wherein the stream of audio and/or video data includes video data, wherein encoding the stream of audio and/or video data includes converting the resolution of the video data to a different value, wherein modifying the encoding of the stream of audio and/or video data includes modifying the value of the resolution to which the video data is converted.

27. A method according to claim 23, wherein encoding the stream of audio and/or video data includes including forward error correcting (“FEC”) codes in the encoded stream of audio and/or video data, wherein modifying the encoding of the stream of audio and/or video data includes modifying a parameter, scheme and/or algorithm used in producing the FEC codes that are included in the encoded stream of audio and/or video data.

28. A method according to claim 23, wherein modifying the encoding of the stream of audio and/or video data occurs dynamically.

29. A method according to claim 23, wherein the method includes, at the server, modifying the encoding of the stream of audio and/or video data based on the received statistics so as to improve the reliability of audio and/or video data obtained at the client devices, if the statistics indicate that the reliability of audio and/or video data obtained at the one or more client devices is inadequate.

30. A method according to claim 23, wherein the method includes, at the server, modifying the encoding of the stream of audio and/or video data based on the received statistics so as to improve the quality of audio and/or video data obtained at the client devices, if the statistics indicate that the reliability of audio and/or video data obtained at the one or more client devices is adequately high to permit an increase in quality.

31. A method according to claim 23, wherein the method includes, at the server, selecting a subset of client devices from which statistics are to be requested and polling the selected subset of client devices to request statistics.

32. A method according to claim 31, wherein the method includes repeatedly selecting and polling a new subset of client devices, wherein each new subset of client devices is selected quasi-randomly or systematically.

33. A method according to claim 31, wherein the rate at which client devices are polled to request statistics is modified based on a measure of traffic in the wireless network.

34. A method according to claim 23, wherein encoding the stream of audio and/or video data includes including FEC codes in the encoded stream of audio and/or video data, wherein the statistics received from the one or more client devices include:
a number of packets of the encoded stream of audio and/or video data received with errors which could be corrected using the FEC codes by each client device; and/or
a number of packets of the encoded stream of audio and/or video data received with errors which could not be corrected using the FEC codes by each client device.

35. A method according to claim 23, wherein the stream of audio and/or video data is a live stream of audio and/or video data.

36. A method according to claim 23, wherein:
the plurality of client devices include 1,000 or more client devices;
the wireless network includes 100 or more wireless access points; and/or the wireless access points are located within 3 km of each other.

37. A server for transmitting audio and/or video data to a plurality of client devices over a wireless network, the server comprising:
a memory and a processor, the server being configured to:
encode a stream of audio and/or video data to provide an encoded stream of audio and/or video data for transmission over the wireless network;
transmit the encoded stream of audio and/or video data to the plurality of client devices over the wireless network;
receive, from one or more of the client devices, statistics derived from the encoded stream of audio and/or video data as received by the one or more client devices; and
modify the encoding of the stream of audio and/or video data based on the received statistics.

38. A method of receiving audio and/or video data from a server over a wireless network, the method comprising, at a client device:
receiving an encoded stream of audio and/or video data over the wireless network, wherein the encoded stream of audio and/or video data was formed by encoding a stream of audio and/or video data;
decoding the encoded stream of audio and/or video data to obtain a decoded stream of audio and/or video data;
collecting statistics derived from the encoded stream of audio and/or video data; and
if the client device is polled by the server, transmitting the statistics to the server over the wireless network.

39. A client device, the client device comprising:
a memory and a processor, the client device configured to:
receive an encoded stream of audio and/or video data over the wireless network, wherein the encoded stream of audio and/or video data was formed by encoding a stream of audio and/or video data;
decode the encoded stream of audio and/or video data to obtain a decoded stream of audio and/or video data;
collect statistics derived from the encoded stream of audio and/or video data; and
if the client device is polled by the server, transmit the statistics to the server over the wireless network.

40. A computer-readable medium having computer-executable instructions configured to cause a server to perform a method comprising:
encoding a stream of audio and/or video data to provide an encoded stream of audio and/or video data for transmission over the wireless network;
transmitting the encoded stream of audio and/or video data to the plurality of client devices over the wireless network;
receiving, from one or more of the client devices, statistics derived from the encoded stream of audio and/or video data as received by the one or more client devices; and
modifying the encoding of the stream of audio and/or video data based on the received statistics.

41. A computer-readable medium having computer-executable instructions configured to cause a client device to perform a method comprising:
receiving an encoded stream of audio and/or video data over the wireless network, wherein the encoded stream of audio and/or video data was formed by encoding a stream of audio and/or video data;
decoding the encoded stream of audio and/or video data to obtain a decoded stream of audio and/or video data;
collecting statistics derived from the encoded stream of audio and/or video data; and
if the client device is polled by the server, transmitting the statistics to the server over the wireless network.

42. A computer-readable medium according to claim 41, wherein the computer-executable instructions are provided as an application downloadable from an online application store.
